(19) United States
(12) Patent Application Publication
(10) Pub. No.: US 2016/0029015 A1
(43) Pub. Date: Jan. 28, 2016

(54) Video quality evaluation method based on 3D wavelet transform

(71) Applicant: Ningbo University, Ningbo (CN)

(72) Inventors: Gangyi Jiang, Ningbo (CN); Yang Song, Ningbo (CN); Shanshan Liu, Ningbo (CN); Kaihui Zheng, Ningbo (CN); Xin Jin, Ningbo (CN)

(73) Assignee: Ningbo University

(21) Appl. No.: 14/486,076

(22) Filed: Sep. 15, 2014

(30) Foreign Application Priority Data
Jul. 25, 2014 (CN) 201410360953.9

(51) Int. Cl. H04N 17/00

(52) U.S. Cl. CPC H04N 17/00; G06T 2207/30168

(57) ABSTRACT

A video quality evaluation method based on 3D wavelet transform utilizes 3D wavelet transform in the video quality evaluation, for transforming the group of pictures (GOP for short) of the video. By splitting the video sequence on a time axis, time-domain information of the GOPs is described, which to a certain extent solves a problem that the video time-domain information is difficult to be described, and effectively improves accuracy of objective video quality evaluation, so as to effectively improve relativity between the objective quality evaluation result and the subjective quality judged by the human eyes. For time-domain relativity between the GOPs, the method weighs the quality of the GOPs according to the motion intensity and the brightness, in such a manner that the method is able to better meet human visual characteristics.

### CROSS REFERENCE OF RELATED APPLICATION

The present invention claims priority under 35 U.S.C. 119(a-d) to CN 201410360953.9, filed Jul. 25, 2014.

### BACKGROUND OF THE PRESENT INVENTION

1. Field of Invention

The present invention relates to a video signal processing technology, and more particularly to a video quality evaluation method based on 3-dimensional (3D for short) wavelet transform.

2. Description of Related Arts

With the rapid development of video coding technology and display technology, different kinds of video systems are applied more and more widely, and gradually become the research focus of the field of information processing. Because of a series of uncontrollable factors, video information will be inevitably distorted in video acquisition, compression, transmission, decoding and display stages, resulting in decrease of video quality. Therefore, how to accurately measure the video quality is the key for the development of video system. Video quality evaluation is divided into subjective and objective quality evaluation. As the visual information is eventually accepted by human eye, the subjective quality evaluation is the most reliable in accuracy. However, subjective quality evaluation requires scoring by observer, which is time-consuming and not easy to be integrated in the video system. The objective quality evaluation model is able to be well integrated in the video system for real-time quality evaluation, which contributes to timely parameter adjustment of the video system, so as to provide a video system application with high quality. Therefore, the objective video quality evaluation method, which is accurate, effective and consistent with human visual characteristics, has a very good application value. The conventional objective video quality evaluation method mainly simulates motion and time-domain video information processing methods of human eyes, and some objective image quality evaluation methods are combined. That is to say, time-domain distortion evaluation of the video is added into the conventional objective image quality evaluation, so as to objectively evaluate the video information quality. Although time-domain information of video sequences are described from different angles according to the above methods, understanding of processing methods of human eye when viewing video information is limited at present. Therefore, time-domain information description according to the above methods is limited, which means it is difficult to evaluate the video time-domain quality, and will eventually lead to poor consistency of objective evaluation results with subjective evaluation visual results.

### SUMMARY OF THE PRESENT INVENTION

An object of the present invention is to provide a video quality evaluation method based on 3D wavelet transform which is able to effectively improve relativity between an objective quality evaluation result and subjective quality judged by human eyes.

Accordingly, in order to accomplish the above object, the present invention provides a video quality evaluation method based on 3D wavelet transform, comprising steps of:

a) marking an original undistorted reference video sequence as V_{ref}, marking a distorted video sequence as V_{dis}, wherein the V_{ref} and the V_{dis} both comprise N_{fr} frames of images, wherein N_{fr}≧2ⁿ, n is a positive integer, and nε[3,5];

b) regarding 2ⁿ frames of images as a group of picture (GOP for short), respectively dividing the V_{ref} and the V_{dis} into n_{GoF} GOPs, marking a No. i GOP in the V_{ref} as G_{ref}ⁱ, marking a No. i GOP in the V_{dis} as G_{dis}ⁱ, wherein

$${n}_{GoF} = ⌊ \frac{{N}_{fr}}{{2}^{n}} ⌋ ,$$

the symbol └ ┘ means down-rounding, and 1≦i≦n_{GoF};

c) applying 2-level 3D wavelet transform on each of the GOPs of the V_{ref}, for obtaining 15 sub-band sequences corresponding to each of the GOPs, wherein the 15 sub-band sequences comprise 7 level-1 sub-band sequences and 8 level-2 sub-band sequences, each of the level-1 sub-band sequences comprises

$$\frac{{2}^{n}}{2}$$

frames of images, and each of the level-2 sub-band sequences comprises

$$\frac{{2}^{n}}{2 \times 2}$$

frames of images;

similarly, applying the 2-level 3D wavelet transform on each of the GOPs of the V_{dis}, for obtaining 15 sub-band sequences corresponding to each of the GOPs, wherein the 15 sub-band sequences are 7 level-1 sub-band sequences and 8 level-2 sub-band sequences, each of the level-1 sub-band sequences comprises

$$\frac{{2}^{n}}{2}$$

frames of images, and each of the level-2 sub-band sequences comprises

$$\frac{{2}^{n}}{2 \times 2}$$

frames of images;

d) calculating quality of each of the sub-band sequences corresponding to the GOPs of the V_{dis}, marking the quality of a No. j sub-band sequence corresponding to the G_{dis}ⁱ as Q^{i,j}, wherein

$${Q}^{i , j} = \frac{{\sum }_{k = 1}^{K} SSIM ( {VI}_{ref}^{i , j , k} , {VI}_{dis}^{i , j , k} )}{K} , 1 \leq j \leq 15 , 1 \leq k \leq K ,$$

K represents a frame quantity of a No. j sub-band sequence corresponding to the G_{ref}ⁱ and the No. j sub-band sequence corresponding to the G_{dis}ⁱ; if the No. j sub-band sequence corresponding to the G_{ref}ⁱ and the No. j sub-band sequence corresponding to the G_{dis}ⁱ are both the level-1 sub-band sequences, then

$$K = \frac{{2}^{n}}{2} ;$$

if the No. j sub-band sequence corresponding to the G_{ref}ⁱ and the No. j sub-band sequence corresponding to the G_{dis}ⁱ are both the level-2 sub-band sequences, then

$$K = \frac{{2}^{n}}{2 \times 2} ;$$

VI_{ref}^{i,j,k} represents a No. k frame of image of the No. j sub-band sequence corresponding to the G_{ref}ⁱ, VI_{dis}^{i,j,k} represents a No. k frame of image of the No. j sub-band sequence corresponding to the G_{dis}ⁱ, SSIM ( ) is a structural similarity function, and

$$SSIM ( {VI}_{ref}^{i , j , k} , {VI}_{dis}^{i , j , k} ) = \frac{( 2 {μ}_{ref} {μ}_{dis} + {c}_{1} ) ( 2 {σ}_{ref - dis} + {c}_{2} )}{( {μ}_{ref}^{2} + {μ}_{dis}^{2} + {c}_{1} ) ( {σ}_{ref}^{2} + {σ}_{dis}^{2} + {c}_{2} )} ,$$

μ_{ref} represents an average value of the VI_{ref}^{i,j,k}, μ_{dis} represents an average value of the VI_{dis}^{i,j,k}, σ_{ref} represents a standard deviation of the VI_{ref}^{i,j,k}, σ_{dis} represents a standard deviation of the VI_{dis}^{i,j,k}, σ_{ref-dis} represents covariance between the VI_{ref}^{i,j,k} and the VI_{dis}^{i,j,k}, c₁ and c₂ are constants, and c₁≠0, c₂≠0;

e) selecting 2 sequences from the 7 level-1 sub-band sequences of each of the GOPs of the V_{dis}, then calculating quality of the level-1 sub-band sequences corresponding to the GOPs of the V_{dis} according to quality of the selected 2 sequences of the level-1 sub-band sequences corresponding to the GOPs of the V_{dis}, wherein for the 7 level-1 sub-band sequences corresponding to the G_{dis}ⁱ, supposing that a No. p₁ sequence and a No. q₁ sequence of the level-1 sub-band sequences are selected, then quality of the level-1 sub-band sequences corresponding to the G_{dis}ⁱ is marked as Q_{Lv1}ⁱ, wherein Q_{Lv1}ⁱ=w_{Lv1}×Q^{i,p}^{₁}+(1−w_{Lv1})×Q^{i,q}^{₁}, 9≦p₁≦15, 9≦q₁≦15, w_{Lv1} is a weight value of Q^{i,p}^{₁}, the Q^{i,p}^{₁} represents the quality of the No. p₁ sequence of the level-1 sub-band sequences corresponding to the G_{dis}ⁱ, Q^{i,q}^{₁} represents the quality of the No. q₁ sequence of the level-1 sub-band sequences corresponding to the G_{dis}ⁱ;

and selecting 2 sequences from the 8 level-2 sub-band sequences of each of the GOPs of the V_{dis}, then calculating quality of the level-2 sub-band sequences corresponding to the GOPs of the V_{dis} according to quality of the selected 2 sequences of the level-2 sub-band sequences corresponding to the GOPs of the V_{dis}, wherein for the 8 level-2 sub-band sequences corresponding to the G_{dis}ⁱ, supposing that a No. p₂ sequence and a No. q₂ sequence of the level-2 sub-band sequences are selected, then quality of the level-2 sub-band sequences corresponding to the G_{dis}ⁱ is marked as Q_{Lv2}ⁱ, wherein Q_{Lv2}ⁱ=w_{Lv2}×Q^{i,p}^{₂}+(1+w_{Lv2})×Q^{i,q}^{₂}, 1≦p₂≦8, 1≦q₂≦8, w_{Lv2} is a weight value of Q^{i,p}^{₂}, the Q^{i,p}^{₂} represents the quality of the No. p₂ sequence of the level-2 sub-band sequences corresponding to the G_{dis}ⁱ, Q^{i,q}^{₂} represents the quality of the No. q₂ sequence of the level-2 sub-band sequences corresponding to the G_{dis}ⁱ;

f) calculating quality of the GOPs of the V_{dis} according to the quality of the level-1 and level-2 sub-band sequences corresponding to the GOPs of the V_{dis}, marking the quality of the G_{dis}ⁱ as Q_{Lv}ⁱ, wherein Q_{Lv}ⁱ=w_{Lv}×Q_{Lv1}ⁱ+(1−w_{Lv})×Q_{Lv2}ⁱ, w_{Lv} is a weight value of the Q_{Lv}ⁱ; and

g) calculating objective evaluated quality of the V_{dis} according to the quality of the GOPs of the V_{dis}, marking the objective evaluated quality as Q, wherein

$$Q = \frac{{\sum }_{i = 1}^{{n}_{GoF}} {w}^{i} \times {Q}_{Lv}^{i}}{{\sum }_{i = 1}^{{n}_{GoF}} {w}^{i}} ,$$

wⁱ is a weight value of the Q_{Lv}ⁱ.

Preferably, for selecting the 2 sequences of the level-1 sub-band sequences and the 2 sequences of the level-2 sub-band sequences, the step e) specifically comprises steps of:

e-1) selecting a video database with subjective video quality as a training video database, obtaining quality of each sub-band sequence corresponding to each GOP of distorted video sequences in the training video database by applying from the step a) to the step d), marking the No. nᵥ distorted video sequence as V_{dis}ⁿ^{ᵥ}, marking quality of a No. j sub-band sequence corresponding to the No. i′ GOP of the V_{dis}ⁿ^{ᵥ} as Qₙ_{ᵥ}^{i′,j}, wherein 1≦nᵥ≦U, U represents a quantity of the distorted sequences in the training video database, 1≦i′≦n_{GoF}′, n_{GoF}′ represents a quantity of the GOPs of the V_{dis}ⁿ^{ᵥ}, 1≦j≦15;

e-2) calculating objective video quality of all the same sub-band sequences corresponding to all the GOPs of the distorted video sequences in the training video database, marking objective video quality of all the No. j sub-band sequences corresponding to all the GOPs of the V_{dis}ⁿ^{ᵥ} as VQₙ_{ᵥ}^{j}, wherein

$${VQ}_{{n}_{v}}^{j} = \frac{{\sum }_{{i}^{′} = 1}^{{n}_{GoF}^{′}} {Q}_{{n}_{v}}^{{i}^{′} , j}}{{n}_{GoF}^{′}} ;$$

e-3) forming a vector v_{X}^{j} with the objective video quality of all the No. j sub-band sequences corresponding to all the GOPs of the distorted video sequences in the training video database, wherein v_{X}^{j}=(VQ₁^{j}, VQ₂^{j}, . . . , VQₙ_{ᵥ}^{j}, . . . , VQ_{U}^{j}); forming a vector v_{Y} with the subjective video quality of all the distorted video sequences in the training video database, wherein v_{Y}=(VS₁, VS₂, . . . , VSₙ_{ᵥ}, . . . , VS_{U}), wherein 1≦j≦15, VQ₁^{j} represents the objective video quality of the No. j sub-band sequences corresponding to all the GOPs of the first distorted video sequence in the training video database, VQ₂^{j} represents the objective video quality of the No. j sub-band sequences corresponding to all the GOPs of the second distorted video sequence in the training video database, VQₙ_{ᵥ}^{j} represents the objective video quality of the No. j sub-band sequences corresponding to all the GOPs of the No. nᵥ distorted video sequence in the training video database, VQ_{U}^{j}, represents the objective video quality of the No. j sub-band sequences corresponding to all the GOPs of the No. U distorted video sequence in the training video database; VS₁ represents the subjective video quality of the first distorted video sequence in the training video database, VS₂ represents the subjective video quality of the second distorted video sequence in the training video database, VSₙ_{ᵥ} represents the subjective video quality of the No. nᵥ distorted video sequence in the training video database, VS_{U} represents the subjective video quality of the No. U distorted video sequence in the training video database;

then calculating a linear correlation coefficient of the objective video quality of the same sub-band sequences corresponding to all the GOPs of the distorted video sequences in the training video database and the subjective quality of the distorted sequences, marking the linear correlation coefficient of the objective video quality of the No. j sub-band sequence corresponding to all the GOPs of the distorted video sequences and the subjective quality of the distorted sequences as CC^{j}, wherein

$${CC}^{j} = \frac{{\sum }_{{n}_{v} = 1}^{U} ( {VQ}_{{n}_{v}}^{j} - {\overline{V}}_{Q}^{j} ) ( {VS}_{{n}_{v}} - {\overline{V}}_{S} )}{\sqrt{{\sum }_{{n}_{v} = 1}^{U} {( {VQ}_{{n}_{v}}^{j} - {\overline{V}}_{Q}^{j} )}^{2}} \sqrt{{\sum }_{{n}_{v} = 1}^{U} {( {VS}_{{n}_{v}} - {\overline{V}}_{S} )}^{2}}} , 1 \leq j \leq 15 ,$$

V̅_{Q}^{j} is an average value of all element values of the v_{X}^{j}, V̅_{S} is an average value of all element values of the v_{Y}; and

e-4) selecting a max linear correlation coefficient and a second max linear correlation coefficient from the 7 linear correlation coefficients corresponding to the 7 level-1 sub-band sequences out of the obtained 15 linear correlation coefficients, regarding the level-1 sub-band sequences respectively corresponding to the max linear correlation coefficient and the second max linear correlation coefficient as the two level-1 sub-band sequences to be selected; and selecting a max linear correlation coefficient and a second max linear correlation coefficient from the 8 linear correlation coefficients corresponding to the 8 level-2 sub-band sequences out of the obtained 15 linear correlation coefficients, regarding the level-2 sub-band sequences respectively corresponding to the max linear correlation coefficient and the second max linear correlation coefficient as the two level-2 sub-band sequences to be selected.

Preferably, in the step e), w_{Lv1}=0.71, and w_{Lv2}=0.58.

Preferably, in the step f), w_{Lv}=0.93.

Preferably, for obtaining the wⁱ, the step g) specifically comprises steps of:

g-1) calculating an average value of brightness average values of all the images in each of the GOPs of the V_{dis}, marking the average value of the brightness average values of all the images of the G_{dis}ⁱ as Lavgⁱ, wherein

$${Lavg}^{i} = \frac{{\sum }_{f = 1}^{{2}^{n}} {\partial }_{f}}{{2}^{n}} ,$$

∂_{f} represents the brightness average value of a No. f frame of image, a value of the ∂_{f} is the brightness average value obtained by averaging brightness values of all pixels in the No. f frame of image, and 1≦i≦n_{GoF};

g-2) calculating an average value of motion intensity of all the images of each of the GOPs except a first frame of image in the GOP, marking the average value of motion intensity of all the images of G_{dis}ⁱ except the first frame of image as MAavgⁱ, wherein

$${MAavg}^{i} = \frac{{\sum }_{{f}^{′} = 2}^{{2}^{n}} {MA}_{{f}^{′}}}{{2}^{n} - 1} , \\ 2 \leq {f}^{′} \leq {2}^{n} ,$$

MA_{f′} represents the motion intensity of the No. f′ frame of image of the G_{dis}ⁱ,

$${MA}_{{f}^{′}} = \frac{1}{W \times H} {\sum }_{s = 1}^{W} {\sum }_{t = 1}^{H} ( {( {mv}_{x} ( s , t ) )}^{2} + {( {mv}_{y} ( s , t ) )}^{2} ) ,$$

represents a width of the No. f′ frame of image of the G_{dis}ⁱ, H represents a height of the No. f′ frame of image of the G_{dis}ⁱ, mvₓ (s,t) represents a horizontal value of a motion vector of a pixel with a position of (s,t) in the No. f′ frame of image of the G_{dis}ⁱ, mv_{y}(s,t) represents a vertical value of the motion vector of the pixel with the position of (s,t) in the No. f′ frame of image of the G_{dis}ⁱ;

g-3) forming a brightness average value vector with the average values of the brightness average values of all the images of the GOPs of the V_{dis}, marking the brightness average value vector as V_{Lavg}, wherein V_{Lavg}=(Lavg¹, Lavg², . . . , Lavgⁿ^{_{GoF}}), Lavg¹ represents an average value of the brightness average values of images of the first GOP of the V_{dis}, Lavg² represents an average value of the brightness average values of images of the second GOP of the V_{dis}, Lavgⁿ^{_{GoF}} represents an average value of the brightness average values of images of the No. n_{GoF} of the V_{dis};

and forming an average value vector of the motion intensity with the average values of the motion intensity of all the images of the GOPs of the V_{dis} except the first frame of image, marking the average value vector of the motion intensity as V_{MAavg}, wherein V_{MAavg}=(MAavg¹, MAavg², . . . , MAavgⁿ^{_{GoF}}), MAavg¹ represents an average value of the motion intensity of images of the first GOP of the V_{dis} except the first frame of image, MAavg² represents an average value of the motion intensity of images of the second GOP of the V_{dis} except the first frame of image, MAavgⁿ^{_{GoF}} represents an average value of the motion intensity of images of the No. n_{GoF} GOP of the V_{dis} except the first frame of image;

g-4) normalizing every element of the V_{Lavg}, for obtaining normalized values of the elements of the V_{Lavg}, marking the normalized value of the No. i element of the V_{Lavg} as v_{Lavg}^{i,norm}, wherein

$${v}_{Lavg}^{i , norm} = \frac{{Lavg}^{i} - max ( {V}_{Lavg} )}{max ( {V}_{Lavg} ) - min ( {V}_{Lavg} )} ,$$

Lavgⁱ represents a value of the No. i element of the V_{Lavg}, max(V_{Lavg}) represents a value of the element with a max value of the V_{Lavg}, min(V_{Lavg}) represents a value of the element with a min value of the V_{Lavg};

and normalizing every element of the V_{MAavg}, for obtaining normalized values of the elements of the V_{MAavg}, marking the normalized value of the No. i element of the V_{MAavg} as v_{MAavg}^{i,norm}, wherein

$${v}_{MAavg}^{i , norm} = \frac{{MAavg}^{i} - max ( {V}_{MAavg} )}{max ( {V}_{MAavg} ) - min ( {V}_{MAavg} )} ,$$

MAavgⁱ represents a value of the No. i element of the V_{MAavg}, max(V_{MAavg}) represents a value of the element with a max value of the v_{MAavg}, min(V_{MAavg}) represents a value of the element with a min value of the V_{MAavg}; and

g-5) calculating the weight value wⁱ of the Q_{Lv}ⁱ according to the v_{Lavg}^{i,norm} and the v_{MAavg}^{i,norm}, wherein wᵢ=(1−v_{MAavg}^{i,norm})×v_{Lavg}^{i,norm}.

Compared to the conventional technologies, the present invention has advantages as follows.

Firstly, according to the present invention, the 3D wavelet transform is utilized in the video quality evaluation, for transforming the GOPs of the video. By splitting the video sequence on a time axis, time-domain information of the GOPs is described, which to a certain extent solves a problem that the video time-domain information is difficult to be described, and effectively improves accuracy of objective video quality evaluation, so as to effectively improve relativity between the objective quality evaluation result and the subjective quality judged by the human eyes.

Secondly, for time-domain relativity between the GOPs, the method weighs the quality of the GOPs according to the motion intensity and the brightness, in such a manner that the method is able to better meet human visual characteristics.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a video quality evaluation method based on 3D wavelet transform according to a preferred embodiment of the present invention.

FIG. 2 is a linear correlation coefficient diagram of objective video quality of the same sub-band sequences and a difference mean opinion score of all distorted video sequences in a LIVE video database according to the preferred embodiment of the present invention.

FIG. 3a is a scatter diagram of objective evaluated quality Q judged by the video quality evaluation method and a difference mean opinion score DMOS of distorted video sequences with wireless transmission distortion according to the preferred embodiment of the present invention.

FIG. 3b is a scatter diagram of objective evaluated quality Q judged by the video quality evaluation method and a difference mean opinion score DMOS of distorted video sequences with IP network transmission distortion according to the preferred embodiment of the present invention.

FIG. 3c is a scatter diagram of objective evaluated quality Q judged by the video quality evaluation method and a difference mean opinion score DMOS of distorted video sequences with H.264 compression distortion according to the preferred embodiment of the present invention.

FIG. 3d is a scatter diagram of objective evaluated quality Q judged by the video quality evaluation method and a difference mean opinion score DMOS of distorted video sequences with MPEG-2 compression distortion according to the preferred embodiment of the present invention.

FIG. 3e is a scatter diagram of objective evaluated quality Q judged by the video quality evaluation method and a difference mean opinion score DMOS of all distorted video sequences in a video quality database according to the preferred embodiment of the present invention.

### DETAILED DESCRIPTION OF THE PREFERRED EMBODIMENT

Referring to the drawings and a preferred embodiment, the present invention is further illustrated.

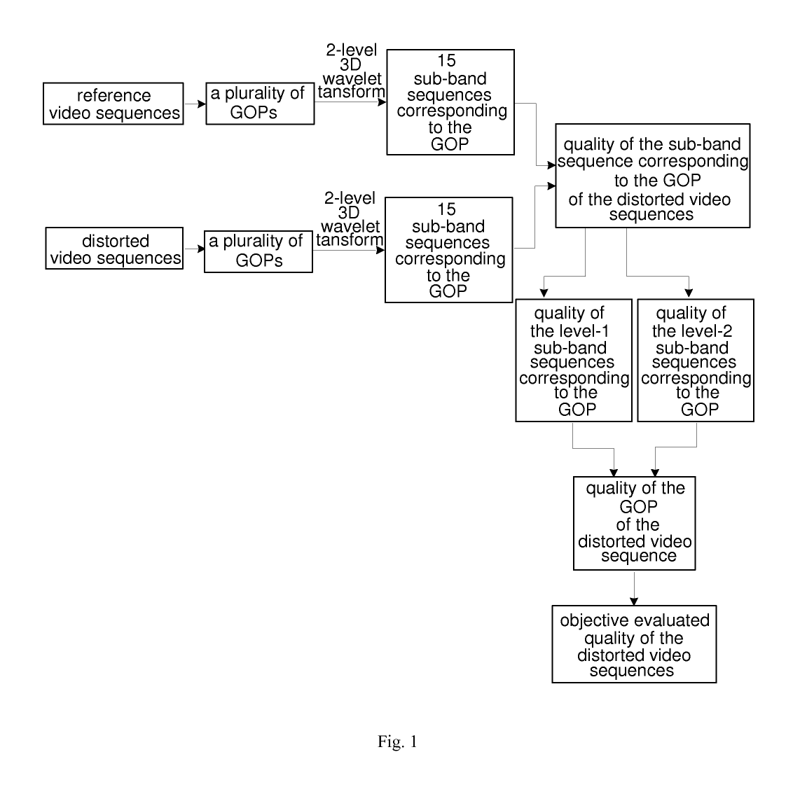

Referring to FIG. 1 of the drawings, a video quality evaluation method based on 3D wavelet transform is illustrated, comprising steps of:

a) marking an original undistorted reference video sequence as V_{ref}, marking a distorted video sequence as V_{dis}, wherein the V_{ref} and the V_{dis} both comprise N_{fr} frames of images, wherein N_{fr}≧2ⁿ, n is a positive integer, and nε[3,5], wherein n=5 in the preferred embodiment;

b) regarding 2ⁿ frames of images as a group of picture (GOP for short), respectively dividing the V_{ref} and the V_{dis} into n_{GoF} GOPs, marking a No. i GOP in the V_{ref} as G_{ref}ⁱ, marking a No. i GOP in the V_{dis} as G_{dis}ⁱ, wherein

$${n}_{GoF} = ⌊ \frac{{N}_{fr}}{2} ⌋ ,$$

the symbol └ ┘ means down-rounding, and 1≦i≦n_{GoF};

wherein in the preferred embodiment, n=5, therefore, each of the GOPs comprises 32 frames of images; in practice, if quantities of the frames of images of the V_{ref} and the V_{dis} are not positive integer times of 2ⁿ, after a plurality of GOPs are obtained orderly, the rest images are omitted;

c) applying 2-level 3D wavelet transform on each of the GOPs of the V_{ref}, for obtaining 15 sub-band sequences corresponding to each of the GOPs, wherein the 15 sub-band sequences comprise 7 level-1 sub-band sequences and 8 level-2 sub-band sequences, each of the level-1 sub-band sequences comprises

$$\frac{{2}^{n}}{2}$$

frames of images, and each of the level-2 sub-band sequences comprises

$$\frac{{2}^{n}}{2 \times 2}$$

frames of images;

wherein the 7 level-1 sub-band sequences corresponding to the GOPs of the V_{ref} comprise: a level-1 reference time-domain low-frequency horizontal detailed sequence LLH_{ref}, a level-1 reference time-domain low-frequency vertical detailed sequence LHL_{ref}, a level-1 reference time-domain low-frequency diagonal detailed sequence LHH_{ref}, a level-1 reference time-domain high-frequency approximated sequence HLL_{ref}, a level-1 reference time-domain high-frequency horizontal detailed sequence HLH_{ref}, a level-1 reference time-domain high-frequency vertical detailed sequence HHL_{ref}, and a level-1 reference time-domain high-frequency diagonal detailed sequence HHH_{ref}; the 8 level-2 sub-band sequences corresponding to the GOPs of the V_{ref} comprise: a level-2 reference time-domain low-frequency approximated sequence LLLL_{ref}, a level-2 reference time-domain low-frequency horizontal detailed sequence LLLH_{ref}, a level-2 reference time-domain low-frequency vertical detailed sequence LLHL_{ref}, a level-2 reference time-domain low-frequency diagonal detailed sequence LLHH_{ref}, a level-2 reference time-domain high-frequency approximated sequence LHLL_{ref}, a level-2 reference time-domain high-frequency horizontal detailed sequence LHLH_{ref}, a level-2 reference time-domain high-frequency vertical detailed sequence LHHL_{ref}, and a level-2 reference time-domain high-frequency diagonal detailed sequence LHHH_{ref};

similarly, applying the 2-level 3D wavelet transform on each of the GOPs of the V_{dis}, for obtaining 15 sub-band sequences corresponding to each of the GOPs, wherein the 15 sub-band sequences are 7 level-1 sub-band sequences and 8 level-2 sub-band sequences, each of the level-1 sub-band sequences comprises

$$\frac{{2}^{n}}{2}$$

frames of images, and each of the level-2 sub-band sequences comprises

$$\frac{{2}^{n}}{2 \times 2}$$

frames of images;

wherein the 7 level-1 sub-band sequences corresponding to the GOPs of the V_{dis} comprise: a level-1 distorted time-domain low-frequency horizontal detailed sequence LLH_{dis}, a level-1 distorted time-domain low-frequency vertical detailed sequence LHL_{dis}, a level-1 distorted time-domain low-frequency diagonal detailed sequence LHH_{dis}, a level-1 distorted time-domain high-frequency approximated sequence HLL_{dis}, a level-1 distorted time-domain high-frequency horizontal detailed sequence HLH_{dis}, a level-1 distorted time-domain high-frequency vertical detailed sequence HHL_{dis}, and a level-1 distorted time-domain high-frequency diagonal detailed sequence HHH_{dis}; the 8 level-2 sub-band sequences corresponding to the GOPs of the V_{dis} comprise: a level-2 distorted time-domain low-frequency approximated sequence LLLL_{dis}, a level-2 distorted time-domain low-frequency horizontal detailed sequence LLLH_{dis}, a level-2 distorted time-domain low-frequency vertical detailed sequence LLHL_{dis}, a level-2 distorted time-domain low-frequency diagonal detailed sequence LLHH_{dis}, a level-2 distorted time-domain high-frequency approximated sequence LHLL_{dis}, a level-2 distorted time-domain high-frequency horizontal detailed sequence LHLH_{dis}, a level-2 distorted time-domain high-frequency vertical detailed sequence LHHL_{dis}, and a level-2 distorted time-domain high-frequency diagonal detailed sequence LHHH_{dis};

wherein the time-domain of the video is split with the 3D wavelet transform; the time-domain information is described from an angle of frequency components, and is treated in a wavelet-domain, which to a certain extent solves a problem that the video time-domain information is difficult to be described in the video quality evaluation, and effectively improves accuracy of the evaluation method;

d) calculating quality of each of the sub-band sequences corresponding to the GOPs of the V_{dis}, marking the quality of a No. j sub-band sequence corresponding to the G_{dis}ⁱ as Q^{i,j}, wherein

$${Q}^{i , j} = \frac{{\sum }_{k = 1}^{K} SSIM ( {VI}_{ref}^{i , j , k} , {VI}_{dis}^{i , j , k} )}{K} ,$$

1≦j≦15, 1≦k≦K, K represents a frame quantity of a No. j sub-band sequence corresponding to the G_{ref}ⁱ and the No. j sub-band sequence corresponding to the G_{dis}ⁱ; if the No. j sub-band sequence corresponding to the G_{ref}ⁱ and the No. j sub-band sequence corresponding to the G_{dis}ⁱ are both the level-1 sub-band sequences, then

$$K = \frac{{2}^{n}}{2} ;$$

if the No. j sub-band sequence corresponding to the G_{ref}ⁱ and the No. j sub-band sequence corresponding to the G_{dis}ⁱ are both the level-2 sub-band sequences, then

$$K = \frac{{2}^{n}}{2 \times 2} ;$$

VI_{ref}^{i,j,k} represents a No. k frame of image of the No. j sub-band sequence corresponding to the G_{ref}ⁱ, VI_{dis}^{i,j,k} represents a No. k frame of image of the No. j sub-band sequence corresponding to the G_{dis}ⁱ, SSIM ( ) is a structural similarity function, and

$$SSIM ( {VI}_{ref}^{i , j , k} , {VI}_{dis}^{i , j , k} ) = \frac{( 2 {μ}_{ref} {μ}_{dis} + {c}_{1} ) ( 2 {σ}_{ref - dis} + {c}_{2} )}{( {μ}_{ref}^{2} + {μ}_{dis}^{2} + {c}_{1} ) ( {σ}_{ref}^{2} + {σ}_{dis}^{2} + {c}_{2} )} ,$$

μ_{ref} represents an average value of the VI_{ref}^{i,j,k}, μ_{dis} represents an average value of the VI_{dis}^{i,j,k}, σ_{ref} represents a standard deviation of the VI_{ref}^{i,j,k}, σ_{dis} represents a standard deviation of the VI_{dis}^{i,j,k}, σ_{ref-dis} represents covariance between the VI_{ref}^{i,j,k} and the VI_{dis}^{i,j,k}, c₁ and c₂ are constants for preventing unstableness of

$$SSIM ( {VI}_{ref}^{i , j , k} , {VI}_{dis}^{i , j , k} ) = \frac{( 2 {μ}_{ref} {μ}_{dis} + {c}_{1} ) ( 2 {σ}_{ref - dis} + {c}_{2} )}{( {μ}_{ref}^{2} + {μ}_{dis}^{2} + {c}_{1} ) ( {σ}_{ref}^{2} + {σ}_{dis}^{2} + {c}_{2} )}$$

when the denominator is close to zero, and c₁≠0, c₂≠0;

e) selecting 2 sequences from the 7 level-1 sub-band sequences of each of the GOPs of the V_{dis}, then calculating quality of the level-1 sub-band sequences corresponding to the GOPs of the V_{dis} according to quality of the selected 2 sequences of the level-1 sub-band sequences corresponding to the GOPs of the V_{dis}, wherein for the 7 level-1 sub-band sequences corresponding to the G_{dis}ⁱ, supposing that a No. p₁ sequence and a No. q₁ sequence of the level-1 sub-band sequences are selected, then quality of the level-1 sub-band sequences corresponding to the G_{dis}ⁱ is marked as Q_{Lv}ⁱ, wherein Q_{Lv1}ⁱ=w_{Lv1}×Q^{i,p}^{₁}+(1−w_{Lv1})×Q^{i,q}^{₁}, 9≦p₁≦15, 9≦q₁≦15, w_{Lv1} is a weight value of the Q^{i,p}^{₁}, the Q^{i,p}^{₁} represents the quality of the No. p₁ sequence of the level-1 sub-band sequences corresponding to the G_{dis}ⁱ, Q^{i,q}^{₁} represents the quality of the No. q₁ sequence of the level-1 sub-band sequences corresponding to the G_{dis}ⁱ; from the No. 9 to the No. 15 sub-band sequences of the 15 sub-band sequences corresponding to the GOPs of the V_{dis} are the level-1 sub-band sequences;

and selecting 2 sequences from the 8 level-2 sub-band sequences of each of the GOPs of the V_{dis}, then calculating quality of the level-2 sub-band sequences corresponding to the GOPs of the V_{dis} according to quality of the selected 2 sequences of the level-2 sub-band sequences corresponding to the GOPs of the V_{dis}, wherein for the 8 level-2 sub-band sequences corresponding to the G_{dis}ⁱ, supposing that a No. p₂ sequence and a No. q₂ sequence of the level-2 sub-band sequences are selected, then quality of the level-2 sub-band sequences corresponding to the G_{dis}ⁱ is marked as Q_{Lv2}ⁱ, wherein Q_{Lv2}ⁱ=w_{Lv2}×Q^{i,p}^{₂}+(1−w_{Lv2})×Q^{i,q}^{₂}, 1≦p₂≦8, 1≦q₂≦8, w_{Lv2} is a weight value of the Q^{i,p}^{₂}, the Q^{i,p}^{₂} represents the quality of the No. p₂ sequence of the level-2 sub-band sequences corresponding to the G_{dis}ⁱ, Q^{i,q}^{₂} represents the quality of the No. q₂ sequence of the level-2 sub-band sequences corresponding to the G_{dis}ⁱ; from the No. 1 to the No. 8 sub-band sequences of the 15 sub-band sequences corresponding to the GOPs of the V_{dis} are the level-2 sub-band sequences;

wherein in the preferred embodiment, w_{Lv1}=0.71, w_{Lv2}=0.58, p₁=9, q₁=12, p₂=3, and q₂=1;

wherein according to the present invention, selection of the No. p₁ and the No. q₁ level-1 sub-band sequences and selection of the No. p₂ and the No. q₂ level-2 sub-band sequences are processes of selecting suitable parameters with statistical analysis, that is to say, the selection is provided with a suitable training video database through following steps e-1) to e-4); after obtaining values of the p₂, q₂, p₁ and q₁, constant values thereof are applicable during video quality evaluation of distorted video sequences with the video quality evaluation method;

wherein for selecting the 2 sequences of the level-1 sub-band sequences and the 2 sequences of the level-2 sub-band sequences, the step e) specifically comprises steps of:

e-1) selecting a video database with subjective video quality as a training video database, obtaining quality of each sub-band sequence corresponding to GOPs of distorted video sequences in the training video database by applying from the step a) to the step d), marking the No. nᵥ distorted video sequence as V_{dis}ⁿ^{ᵥ}, marking quality of a No. j sub-band sequence corresponding to the No. i′ GOP of the V_{dis}ⁿ^{ᵥ} as Qₙ_{ᵥ}^{i′,j}, wherein 1≦nᵥ≦U, U represents a quantity of the distorted sequences in the training video database, 1≦i′≦n_{GoF}′, n_{GoF}′ represents a quantity of the GOPs of the V_{dis}ⁿ^{ᵥ}, 1≦j≦15;

e-2) calculating objective video quality of all the same sub-band sequences corresponding to all the GOPs of the distorted video sequences in the training video database, marking objective video quality of all the No. j sub-band sequences corresponding to all the GOPs of the V_{dis}ⁿ^{ᵥ} as VQₙ_{ᵥ}^{j}, wherein

$${VQ}_{{n}_{v}}^{j} = \frac{{\sum }_{{i}^{′} = 1}^{{n}_{GoF}^{′}} {Q}_{{n}_{v}}^{{i}^{′} , j}}{{n}_{GoF}^{′}} ;$$

e-3) forming a vector v_{X}^{j} with the objective video quality of all the No. j sub-band sequences corresponding to all the GOPs of the distorted video sequences in the training video database, wherein v_{X}^{j}=(VQ₁^{j}, VQ₂^{j}, . . . , VQₙ_{ᵥ}^{j}, . . . , VQ_{U}^{j}), wherein a vector is formed for each of the same sub-band sequences, that is to say, there are 15 vectors respectively corresponding to the 15 sub-band sequences; forming a vector v_{Y} with the subjective video quality of all the distorted video sequences in the training video database, wherein v_{Y}=(VS₁, VS₂, . . . , VSₙ_{ᵥ}, . . . , VS_{U}), wherein 1≦j≦15, VQ₁^{j} represents the objective video quality of the No. j sub-band sequences corresponding to all the GOPs of the first distorted video sequence in the training video database, VQ₂^{j} represents the objective video quality of the No. j sub-band sequences corresponding to all the GOPs of the second distorted video sequence in the training video database, VQₙ_{ᵥ}^{j} represents the objective video quality of the No. j sub-band sequences corresponding to all the GOPs of the No. nᵥ distorted video sequence in the training video database, VQ_{U}^{j} represents the objective video quality of the No. j sub-band sequences corresponding to all the GOPs of the No. U distorted video sequence in the training video database; VS₁ represents the subjective video quality of the first distorted video sequence in the training video database, VS₂ represents the subjective video quality of the second distorted video sequence in the training video database, VSₙ_{ᵥ} represents the subjective video quality of the No. nᵥ distorted video sequence in the training video database, VS_{U} represents the subjective video quality of the No. U distorted video sequence in the training video database;

then calculating a linear correlation coefficient of the objective video quality of the same sub-band sequences corresponding to all the GOPs of the distorted video sequences in the training video database and the subjective quality of the distorted sequences, marking the linear correlation coefficient of the objective video quality of the No. j sub-band sequence corresponding to all the GOPs of the distorted video sequences and the subjective quality of the distorted sequences as CC^{j}, wherein

$${CC}^{j} = \frac{{\sum }_{{n}_{v} = 1}^{U} ( {VQ}_{{n}_{v}}^{j} - {\overline{V}}_{Q}^{j} ) ( {VS}_{{n}_{v}} - {\overline{V}}_{S} )}{\sqrt{{\sum }_{{n}_{v} = 1}^{U} {( {VQ}_{{n}_{v}}^{j} - {\overline{V}}_{Q}^{j} )}^{2}} \sqrt{{\sum }_{{n}_{v} = 1}^{U} {( {VS}_{{n}_{v}} - {\overline{V}}_{S} )}^{2}}} , 1 \leq j \leq 15 ,$$

V̅_{Q}^{j} is an average value of all element values of the v_{X}^{j}, V̅_{S} is an average value of all element values of the v_{Y}; and

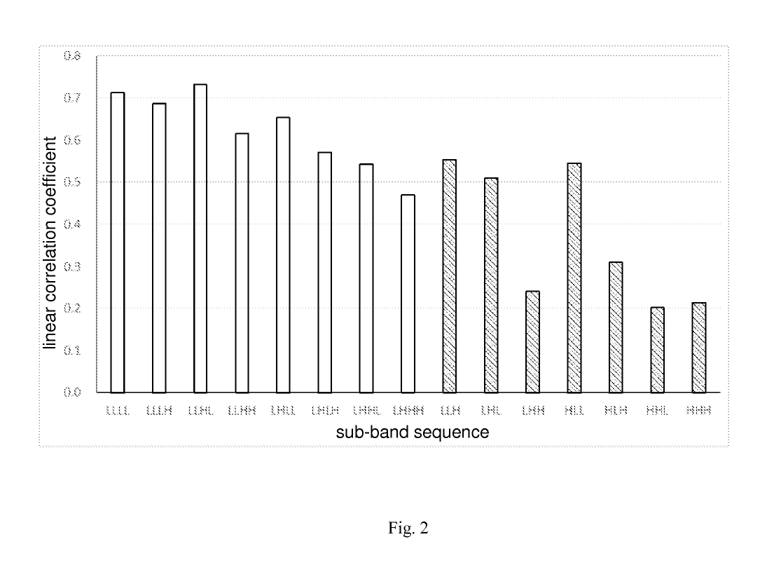

e-4) after obtaining the 15 linear correlation coefficients in the step e-3), selecting a max linear correlation coefficient and a second max linear correlation coefficient from the 7 linear correlation coefficients corresponding to the 7 level-1 sub-band sequences out of the obtained 15 linear correlation coefficients, regarding the level-1 sub-band sequences respectively corresponding to the max linear correlation coefficient and the second max linear correlation coefficient as the two level-1 sub-band sequences to be selected; and selecting a max linear correlation coefficient and a second max linear correlation coefficient from the 8 linear correlation coefficients corresponding to the 8 level-2 sub-band sequences out of the obtained 15 linear correlation coefficients, regarding the level-2 sub-band sequences respectively corresponding to the max linear correlation coefficient and the second max linear correlation coefficient as the two level-2 sub-band sequences to be selected;

wherein in the preferred embodiment, for selecting the No. p₂ and the No. q₂ level-2 sub-band sequences, and the No. p₁ and the No. q₁ level-1 sub-band sequences, a distorted video collection with 4 different distortion types and different distortion degrees based on 10 undistorted video sequences in a LIVE video quality database from University of Texas at Austin is utilized; the distorted video collection comprises: 40 distorted video sequences with wireless transmission distortion, 30 distorted video sequences with IP network transmission distortion, 40 distorted video sequences with H.264 compression distortion, and 40 distorted video sequences with MPEG-2 compression distortion; each of the distorted video sequences has a corresponding subjective quality evaluation result which is represented by a difference mean opinion score DMOS; that is to say, a subjective quality evaluation result VSₙ_{ᵥ} of the No. nᵥ distorted video sequence in the training video database of the preferred embodiment is marked as DMOSₙ_{ᵥ}; by applying from the step a) to the step e) of the video quality evaluation method on the above distorted video sequences, objective video quality of the same sub-band sequences corresponding to all GOPs of the distorted video sequence is obtained by calculating, which means that there are 15 objective video quality corresponding to the 15 sub-band sequences for each distorted video sequence; then by applying the step e-3) for calculating a linear correlation coefficient of the objective video quality of the sub-band sequence corresponding to the distorted video sequences and a corresponding difference mean opinion score DMOS of the distorted video sequences, linear correlation coefficients corresponding to the objective video quality of the 15 sub-band sequences of the distorted video sequences are obtained; referring to the FIG. 2, a linear correlation coefficient diagram of the objective video quality of the same sub-band sequences and the difference mean opinion scores of all the distorted video sequences in the LIVE video database is illustrated, wherein in the 7 level-1 sub-band sequences, LLH_{dis} has the max linear correlation coefficient, and HLL_{dis} has the second max linear correlation coefficient, which means p₁=9, and q₁=12; wherein in the 8 level-2 sub-band sequences, LLHL_{dis} has the max linear correlation coefficient, and LLLL_{dis} has the second max linear correlation coefficient, which means p₂=3, and q₂=1; the larger the linear correlation coefficient is, the more accurate the objective quality of the sub-band sequence is when compared to the subject video quality; therefore, the sub-band sequences with the max and the second max linear correlation coefficients according to the subject video quality are selected from the level-1 and level-2 sub-band sequences for further calculating;

f) calculating quality of the GOPs of the V_{dis} according to the quality of the level-1 and level-2 sub-band sequences corresponding to the GOPs of the V_{dis}, marking the quality of the G_{dis}ⁱ as Q_{Lv}ⁱ, wherein Q_{Lv}ⁱ=w_{Lv}×Q_{Lv1}ⁱ+(1−w_{Lv})×Q_{Lv2}ⁱ, w_{Lv} is a weight value of the Q_{Lv1}ⁱ, in the preferred embodiment, w_{Lv}=0.93; and

g) calculating objective evaluated quality of the V_{dis} according to the quality of the GOPs of the V_{dis}, marking the objective evaluated quality as Q, wherein

$$Q = \frac{{\sum }_{i = 1}^{{n}_{GoF}} {w}^{i} \times {Q}_{Lv}^{i}}{{\sum }_{i = 1}^{{n}_{GoF}} {w}^{i}} ,$$

wⁱ is a weight value of the Q_{Lv}ⁱ; wherein for obtaining the wⁱ, the step g) specifically comprises steps of:

g-1) calculating an average value of brightness average values of all the images in each of the GOPs of the V_{dis}, marking the average value of the brightness average values of all the images of the G_{dis}ⁱ as Lavgⁱ, wherein

$${Lavg}^{i} = \frac{{\sum }_{f = 1}^{{2}^{n}} {\partial }_{f}}{{2}^{n}} ,$$

∂_{f} represents the brightness average value of a No. f frame of image, a value of the ∂_{f} is the brightness average value obtained by averaging brightness values of all pixels in the No. f frame of image, and 1≦i≦n_{GoF};

g-2) calculating an average value of motion intensity of all the images of each of the GOPs except a first frame of image in the GOP, marking the average value of motion intensity of all the images of G_{dis}ⁱ except the first frame of image as MAavgⁱ, wherein

$${MAavg}^{i} = \frac{{\sum }_{{f}^{′} = 2}^{{2}^{n}} {MA}_{{f}^{′}}}{{2}^{n} - 1} , 2 \leq {f}^{′} \leq {2}^{n} ,$$

MA_{f′} represents the motion intensity of the No. f′ frame of image of the G_{dis}ⁱ,

$${MA}_{{f}^{′}} = \frac{1}{W \times H} {\sum }_{s = 1}^{W} {\sum }_{t = 1}^{H} ( {( {mv}_{x} ( s , t ) )}^{2} + {( {mv}_{y} ( s , t ) )}^{2} ) ,$$

W represents a width of the No. f′ frame of image of the G_{dis}ⁱ, H represents a height of the No. f′ frame of image of the G_{dis}ⁱ, mvₓ (s,t) represents a horizontal value of a motion vector of a pixel with a position of (s,t) in the No. f′ frame of image of the G_{dis}ⁱ, mv_{y}(s,t) represents a vertical value of the motion vector of the pixel with the position of (s,t) in the No. f′ frame of image of the G_{dis}ⁱ; the motion vector of each of the pixels in the No. f′ frame of image of the G_{dis}ⁱ is obtained with a reference to a former frame of image of the No. f′ frame of image of the G_{dis}ⁱ;

g-3) forming a brightness average value vector with the average values of the brightness average values of all the images of the GOPs of the V_{dis}, marking the brightness average value vector as V_{Lavg} wherein V_{Lavg}=(Lavg¹, Lavg², . . . , Lavgⁿ^{_{GoF}}), Lavg¹ represents an average value of the brightness average values of images of the first GOP of the V_{dis}, Lavg² represents an average value of the brightness average values of images of the second GOP of the V_{dis}, Lavgⁿ^{_{GoF}} represents an average value of the brightness average values of images of the No. n_{GoF} GOP of the V_{dis};

and forming an average value vector of the motion intensity with the average values of the motion intensity of all the images of the GOPs of the V_{dis} except the first frame of image, marking the average value vector of the motion intensity as V_{MAavg}, wherein V_{MAavg}=(MAavg¹, MAavg², . . . , MAavgⁿ^{_{GoF}}), MAavg¹ represents an average value of the motion intensity of images of the first GOP of the V_{dis} except the first frame of image, MAavg² represents an average value of the motion intensity of images of the second GOP of the V_{dis} except the first frame of image, MAavgⁿ^{_{GoF}} represents an average value of the motion intensity of images of the No. n_{GoF} GOP of the V_{dis} except the first frame of image;

g-4) normalizing every element of the V_{Lavg}, for obtaining normalized values of the elements of the V_{Lavg}, marking the normalized value of the No. i element of the V_{Lavg} as v_{Lavg}^{i,norm}, wherein

$${v}_{Lavg}^{i , norm} = \frac{{Lavg}^{i} - max ( {V}_{Lavg} )}{max ( {V}_{Lavg} ) - min ( {V}_{Lavg} )} ,$$

Lavgⁱ represents a value of the No. i element of the V_{Lavg}, max(V_{Lavg}) represents a value of the element with a max value of the V_{Lavg}, min(V_{Lavg}) represents a value of the element with a min value of the V_{Lavg};

and normalizing every element of the V_{MAavg}, for obtaining normalized values of the elements of the V_{MAavg}, marking the normalized value of the No. i element of the V_{MAavg} as v_{MAavg}^{i,norm}, wherein

$${v}_{MAavg}^{i , norm} = \frac{{MAavg}^{i} - max ( {V}_{MAavg} )}{max ( {V}_{MAavg} ) - min ( {V}_{MAavg} )} ,$$

MAavgⁱ represents a value of the No. i element of the V_{MAavg}, max(V_{MAavg}) represents a value of the element with a max value of the V_{MAavg}, min(V_{MAavg}) represents a value of the element with a min value of the V_{MAavg}; and

g-5) calculating the weight value wⁱ of the Q_{Lv}ⁱ according to the v_{Lavg}^{i,norm} and the v_{MAavg}^{i,norm}, wherein wⁱ=(1−v_{MAavg}^{i,norm})×v_{Lavg}^{i,norm}.

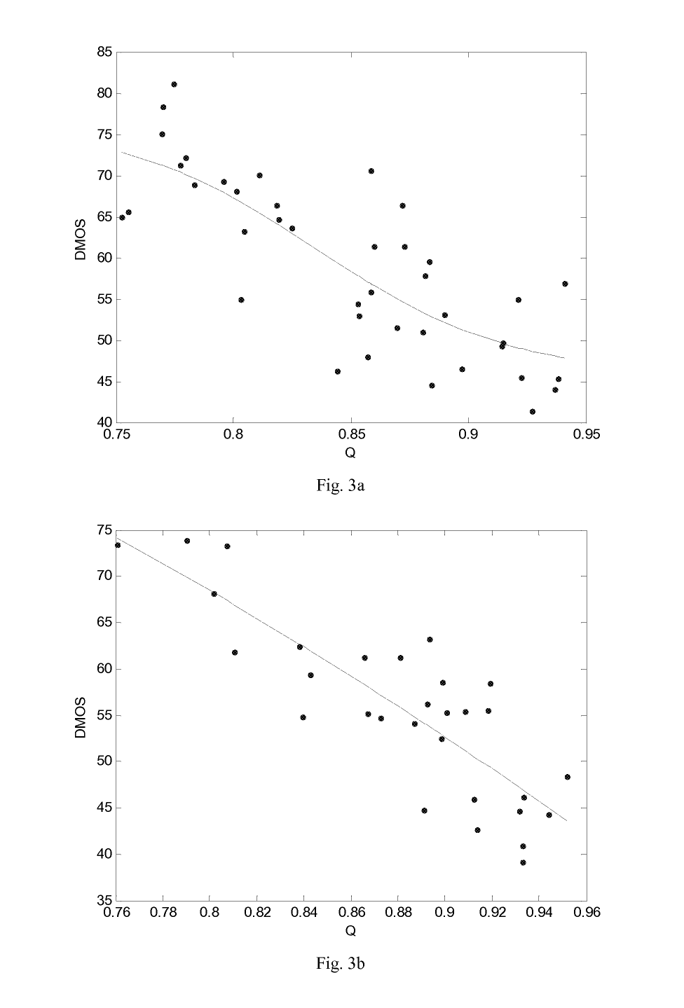

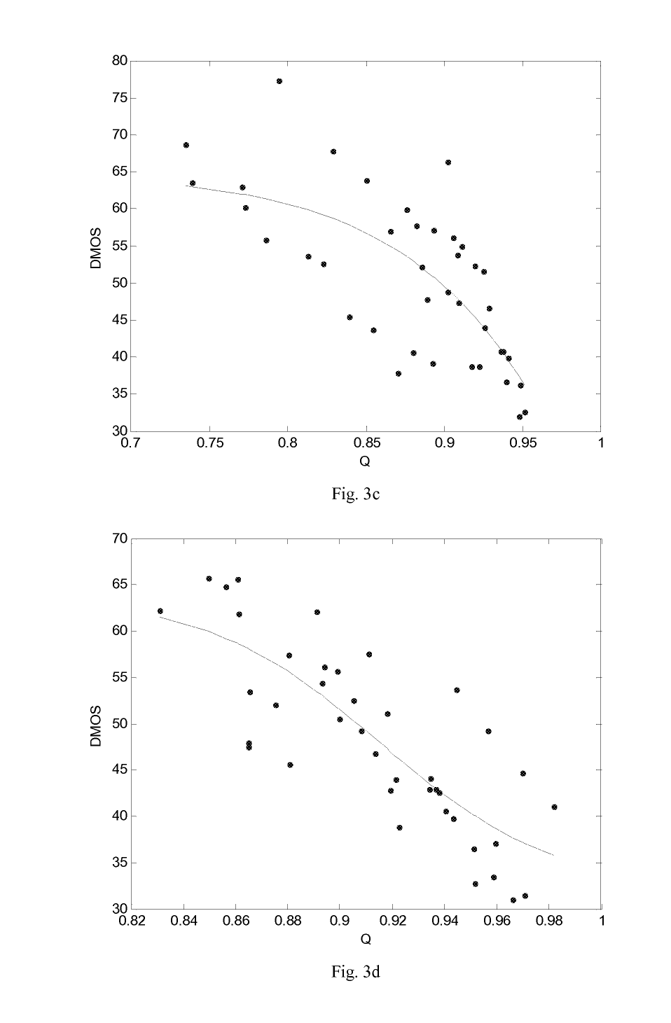

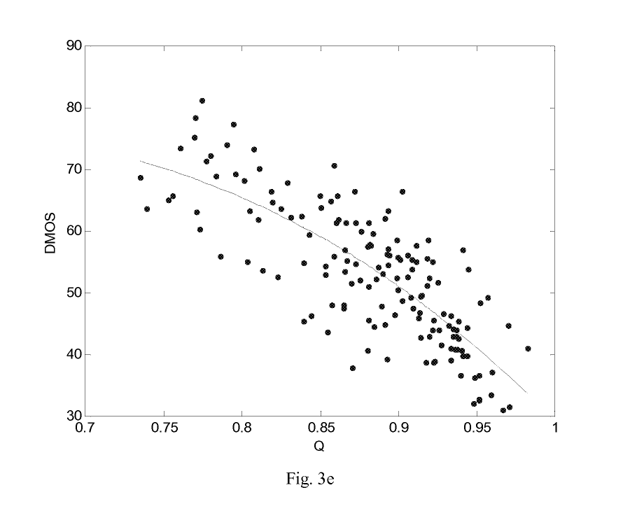

For illustrating effectiveness and feasibility of the present invention, the LIVE video quality database from University of Texas at Austin is utilized for experimental verification, so as to analyze relativity of the objective evaluated result and the difference mean opinion score. The distorted video collection with 4 different distortion types and different distortion degrees is formed based on the 10 undistorted video sequences in the LIVE video quality database, the distorted video collection comprises: 40 distorted video sequences with wireless transmission distortion, 30 distorted video sequences with IP network transmission distortion, 40 distorted video sequences with H.264 compression distortion, and 40 distorted video sequences with MPEG-2 compression distortion. Referring to FIG. 3a, a scatter diagram of objective evaluated quality Q judged by the video quality evaluation method and a difference mean opinion score DMOS of the 40 distorted video sequences with wireless transmission distortion is illustrated. Referring to FIG. 3b, a scatter diagram of objective evaluated quality Q judged by the video quality evaluation method and a difference mean opinion score DMOS of the 30 distorted video sequences with IP network transmission distortion is illustrated. Referring to FIG. 3c, a scatter diagram of objective evaluated quality Q judged by the video quality evaluation method and a difference mean opinion score DMOS of the 40 distorted video sequences with H.264 compression distortion is illustrated. Referring to FIG. 3d, a scatter diagram of objective evaluated quality Q judged by the video quality evaluation method and a difference mean opinion score DMOS of the 40 distorted video sequences with MPEG-2 compression distortion is illustrated. And referring to FIG. 3e, a scatter diagram of objective evaluated quality Q judged by the video quality evaluation method and a difference mean opinion score DMOS of all the 150 distorted video sequences is illustrated. In the FIGS. 3a-3e, the higher concentration of the scatters, the better objective quality evaluation performance and relativity with the DMOS. According to the FIGS. 3a-3e, the video quality evaluation method is able to well separate the sequences with low quality from the sequences with high quality, and has good evaluation performance.

Herein, 4 common parameters for evaluating the performance of video quality evaluation method are utilized, that is, Pearson correlation coefficient under nonlinear regression (CC for short), Spearman rank order correlation coefficient (SROCC for short), outlier ratio (OR for short), and rooted mean squared error (RMSE for short). CC represents accuracy of the objective quality evaluation method, and SROCC represents prediction monotonicity of the objective quality evaluation method, wherein the CC and the SROCC being closer to 1 means that the performance of the objective quality evaluation method is better. OR represents dispersion degree of the objective quality evaluation method, wherein the OR being closer to 0 means that the objective quality evaluation method is better. RMSE represents prediction accuracy of the objective quality evaluation method, the RMSE being smaller means that the objective quality evaluation method is better. CC, SROCC, OR and RMSE coefficients representing accuracy, monotonicity and dispersion ratio of the video quality evaluation method according to the present invention are illustrated in a Table. 1. Referring to the Table. 1, overall hybrid distortion CC and SROCC are both above 0.79, wherein CC is above 0.8. OR is 0, RMSE is lower than 6.5. According to the present invention, the relativity of the objective evaluated quality Q and the difference mean opinion score DMOS obtained is high, which illustrates sufficient consistency of objective evaluation results with subjective evaluation visual results, and well illustrates the effectiveness of the present invention.

TABLE 1
Evaluation result of the 4 performance parameters according
to the method of the present invention

| | CC | SROCC | OR | RMSE |
|---|---|---|---|---|
| 40 distorted video sequences with | 0.8087 | 0.8047 | 0 | 6.2066 |
| wireless transmission distortion | | | | |
| 30 distorted video sequences with IP | 0.8663 | 0.7958 | 0 | 4.8318 |
| network transmission distortion | | | | |
| 40 distorted video sequences with | 0.7403 | 0.7257 | 0 | 7.4110 |
| H.264 compression distortion | | | | |
| 40 distorted video sequences with | 0.8140 | 0.7979 | 0 | 5.6653 |
| MPEG-2 compression distortion | | | | |
| All the 150 distorted video sequences | 0.8037 | 0.7931 | 0 | 6.4570 |

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A video quality evaluation method based on 3D wavelet transform, comprising steps of:
a) marking an original undistorted reference video sequence as V_{ref}, marking a distorted video sequence as V_{dis}, wherein the V_{ref} and the V_{dis} both comprise N_{fr} frames of images, wherein N_{fr}≧2ⁿ, n is a positive integer, and nε[3,5];
b) regarding 2ⁿ frames of images as a group of picture (GOP for short), respectively dividing the V_{ref} and the V_{dis} into n_{GoF} GOPs, marking a No. i GOP in the V_{ref} as G_{ref}ⁱ, marking a No. i GOP in the V_{dis} as G_{dis}ⁱ, wherein
$${n}_{GoF} = ⌊ \frac{{N}_{fr}}{{2}^{n}} ⌋ ,$$
the symbol └ ┘ means down-rounding, and 1≦i≦n_{GoF};
c) applying 2-level 3D wavelet transform on each of the GOPs of the V_{ref}, for obtaining 15 sub-band sequences corresponding to each of the GOPs, wherein the 15 sub-band sequences comprise 7 level-1 sub-band sequences and 8 level-2 sub-band sequences, each of the level-1 sub-band sequences comprises
$$\frac{{2}^{n}}{2}$$
frames of images, and each of the level-2 sub-band sequences comprises
$$\frac{{2}^{n}}{2 \times 2}$$
frames of images;
similarly, applying the 2-level 3D wavelet transform on each of the GOPs of the V_{dis}, for obtaining 15 sub-band sequences corresponding to each of the GOPs, wherein the 15 sub-band sequences are 7 level-1 sub-band sequences and 8 level-2 sub-band sequences, each of the level-1 sub-band sequences comprises
$$\frac{{2}^{n}}{2}$$
frames of images, and each of the level-2 sub-band sequences comprises
$$\frac{{2}^{n}}{2 \times 2}$$
frames of images;
d) calculating quality of each of the sub-band sequences corresponding to the GOPs of the V_{dis}, marking the quality of a No. j sub-band sequence corresponding to the G_{dis}ⁱ as Q^{i,j}, wherein
$${Q}^{i , j} = \frac{{\sum }_{k = 1}^{K} SSIM ( {VI}_{ref}^{i , j , k} , {VI}_{dis}^{i , j , k} )}{K} , 1 \leq j \leq 15 , 1 \leq k \leq K ,$$
K represents a frame quantity of a No. j sub-band sequence corresponding to the G_{ref}ⁱ and the No. j sub-band sequence corresponding to the G_{dis}ⁱ; if the No. j sub-band sequence corresponding to the G_{ref}ⁱ and the No. j sub-band sequence corresponding to the G_{dis}ⁱ are both the level-1 sub-band sequences, then
$$K = \frac{{2}^{n}}{2} ;$$
if the No. j sub-band sequence corresponding to the G_{ref}ⁱ and the No. j sub-band sequence corresponding to the G_{dis}ⁱ are both the level-2 sub-band sequences, then
$$K = \frac{{2}^{n}}{2 \times 2} ;$$
VI_{ref}^{i,j,k} represents a No. k frame of image of the No. j sub-band sequence corresponding to the G_{ref}ⁱ, VI_{dis}^{i,j,k} represents a No. k frame of image of the No. j sub-band sequence corresponding to the G_{dis}ⁱ, SSIM ( ) is a structural similarity function, and
$$SSIM ( {VI}_{ref}^{i , j , k} , {VI}_{dis}^{i , j , k} ) = \frac{( 2 {μ}_{ref} {μ}_{dis} + {c}_{1} ) ( 2 {σ}_{ref - dis} + {c}_{2} )}{( {μ}_{ref}^{2} + {μ}_{dis}^{2} + {c}_{1} ) ( {σ}_{ref}^{2} + {σ}_{dis}^{2} + {c}_{2} )} ,$$
μ_{ref} represents an average value of the VI_{ref}^{i,j,k}, μ_{dis} represents an average value of the VI_{dis}^{i,j,k}, σ_{ref} represents a standard deviation of the VI_{ref}^{i,j,k}, σ_{dis} represents a standard deviation of the VI_{dis}^{i,j,k}, σ_{ref-dis} represents covariance between the VI_{ref}^{i,j,k} and the VI_{dis}^{i,j,k}, c₁ and c₂ are constants, and c₁≠0, c₂≠0;
e) selecting 2 sequences from the 7 level-1 sub-band sequences of each of the GOPs of the V_{dis}, then calculating quality of the level-1 sub-band sequences corresponding to the GOPs of the V_{dis} according to quality of the selected 2 sequences of the level-1 sub-band sequences corresponding to the GOPs of the V_{dis}, wherein for the 7 level-1 sub-band sequences corresponding to the G_{dis}ⁱ, supposing that a No. p₁ sequence and a No. q₁ sequence of the level-1 sub-band sequences are selected, then quality of the level-1 sub-band sequences corresponding to the G_{dis}ⁱ is marked as Q_{Lv1}ⁱ, wherein Q_{Lv1}ⁱ=w_{Lv1}×Q^{i,p}^{₁}+(1−w_{Lv1})×Q^{i,q}^{₁}, 9≦p₁≦15, 9≦q₁≦15, w_{Lv1} is a weight value of Q^{i,p}^{₁}, the Q^{i,p}^{₁} represents the quality of the No. p₁ sequence of the level-1 sub-band sequences corresponding to the G_{dis}ⁱ, Q^{i,q}^{₁} represents the quality of the No. q₁ sequence of the level-1 sub-band sequences corresponding to the G_{dis}ⁱ;
and selecting 2 sequences from the 8 level-2 sub-band sequences of each of the GOPs of the V_{dis}, then calculating quality of the level-2 sub-band sequences corresponding to the GOPs of the V_{dis} according to quality of the selected 2 sequences of the level-2 sub-band sequences corresponding to the GOPs of the V_{dis}, wherein for the 8 level-2 sub-band sequences corresponding to the G_{dis} supposing that a No. p₂ sequence and a No. q₂ sequence of the level-2 sub-band sequences are selected, then quality of the level-2 sub-band sequences corresponding to the G_{dis}ⁱ is marked as Q_{Lv2}ⁱ, wherein Q_{Lv2}ⁱ=w_{Lv2}×Q^{i,p}^{₂}+(1−w_{Lv2})×Q^{i,q}^{₂}, 1≦p₂≦8, 1≦q₂≦8, w_{Lv2} is a weight value of Q^{i,p}^{₂}, the Q^{i,p}^{₂} represents the quality of the No. p₂ sequence of the level-2 sub-band sequences corresponding to the G_{dis}ⁱ, Q^{i,q}^{₂} represents the quality of the No. q₂ sequence of the level-2 sub-band sequences corresponding to the G_{dis}ⁱ;
f) calculating quality of the GOPs of the V_{dis} according to the quality of the level-1 and level-2 sub-band sequences corresponding to the GOPs of the V_{dis}, marking the quality of the G_{dis}ⁱ as Q_{Lv}ⁱ, wherein Q_{Lv}ⁱ=w_{Lv}×Q_{Lv1}ⁱ+(1−w_{Lv})×Q_{Lv2}ⁱ, w_{Lv} is a weight value of the Q_{Lv1}ⁱ; and
g) calculating objective evaluated quality of the V_{dis} according to the quality of the GOPs of the V_{dis}, marking the objective evaluated quality as Q, wherein
$$Q = \frac{{\sum }_{i = 1}^{{n}_{GoF}} {w}^{i} \times {Q}_{Lv}^{i}}{{\sum }_{i = 1}^{{n}_{GoF}} {w}^{i}} ,$$
wⁱ is a weight value of the Q_{Lv}ⁱ.

2. The video quality evaluation method, as recited in claim 1, wherein for selecting the 2 sequences of the level-1 sub-band sequences and the 2 sequences of the level-2 sub-band sequences, the step e) specifically comprises steps of:
e-1) selecting a video database with subjective video quality as a training video database, obtaining quality of each sub-band sequence corresponding to each GOP of distorted video sequences in the training video database by applying from the step a) to the step d), marking the No. nᵥ distorted video sequence as V_{dis}ⁿ^{ᵥ}, marking quality of a No. j sub-band sequence corresponding to the No. i′ GOP of the V_{dis}ⁿ^{ᵥ} as Qₙ_{ᵥ}^{i′,j}, wherein 1≦nᵥ≦U, U represents a quantity of the distorted sequences in the training video database, 1≦i′≦n_{GoF}′, n_{GoF}′ represents a quantity of the GOPs of the V_{dis}ⁿ^{ᵥ}, 1≦j≦15;
e-2) calculating objective video quality of all the same sub-band sequences corresponding to all the GOPs of the distorted video sequences in the training video database, marking objective video quality of all the No. j sub-band sequences corresponding to all the GOPs of the V_{dis}ⁿ^{ᵥ} as VQₙ_{ᵥ}^{j}, wherein
$${VQ}_{{n}_{v}}^{j} = \frac{{\sum }_{{i}^{′} = 1}^{{n}_{GoF}^{′}} {Q}_{{n}_{v}}^{{i}^{′} , j}}{{n}_{GoF}^{′}} ;$$
e-3) forming a vector v_{X}^{j} with the objective video quality of all the No. j sub-band sequences corresponding to all the GOPs of the distorted video sequences in the training video database, wherein v_{X}^{j}=(VQ₁^{j}, VQ₂^{j}, . . . , VQₙ^{j}, . . . , VQ_{U}^{j}); forming a vector v_{Y} with the subjective video quality of all the distorted video sequences in the training video database, wherein v_{Y}=(VS₁, VS₂, . . . , VSₙ_{ᵥ}, . . . , VS_{U}), wherein 1≦j≦15, VQ₁^{j} represents the objective video quality of the No. j sub-band sequences corresponding to all the GOPs of the first distorted video sequence in the training video database, VQ₂^{j} represents the objective video quality of the No. j sub-band sequences corresponding to all the GOPs of the second distorted video sequence in the training video database, VQₙ^{j}, represents the objective video quality of the No. j sub-band sequences corresponding to all the GOPs of the No. nᵥ distorted video sequence in the training video database, VQ_{U}^{j} represents the objective video quality of the No. j sub-band sequences corresponding to all the GOPs of the No. U distorted video sequence in the training video database; VS₁ represents the subjective video quality of the first distorted video sequence in the training video database, VS₂ represents the subjective video quality of the second distorted video sequence in the training video database, VSₙ_{ᵥ} represents the subjective video quality of the No. nᵥ distorted video sequence in the training video database, VS_{U} represents the subjective video quality of the No. U distorted video sequence in the training video database;
then calculating a linear correlation coefficient of the objective video quality of the same sub-band sequences corresponding to all the GOPs of the distorted video sequences in the training video database and the subjective quality of the distorted sequences, marking the linear correlation coefficient of the objective video quality of the No. j sub-band sequence corresponding to all the GOPs of the distorted video sequences and the subjective quality of the distorted sequences as CC^{j}, wherein
$${CC}^{j} = \frac{{\sum }_{{n}_{v} = 1}^{U} ( {VQ}_{{n}_{v}}^{j} - {\overline{V}}_{Q}^{j} ) ( {VS}_{{n}_{v}} - {\overline{V}}_{S} )}{\sqrt{{\sum }_{{n}_{v} = 1}^{U} {( {VQ}_{{n}_{v}}^{j} - {\overline{V}}_{Q}^{j} )}^{2}} \sqrt{{\sum }_{{n}_{v} = 1}^{U} {( {VS}_{{n}_{v}} - {\overline{V}}_{S} )}^{2}}} , 1 \leq j \leq 15 ,$$
V̅_{Q}^{j} is an average value of all element values of the v_{X}^{j}, V̅_{S} is an average value of all element values of the v_{Y}; and
e-4) selecting a max linear correlation coefficient and a second max linear correlation coefficient from the 7 linear correlation coefficients corresponding to the 7 level-1 sub-band sequences out of the obtained 15 linear correlation coefficients, regarding the level-1 sub-band sequences respectively corresponding to the max linear correlation coefficient and the second max linear correlation coefficient as the two level-1 sub-band sequences to be selected; and selecting a max linear correlation coefficient and a second max linear correlation coefficient from the 8 linear correlation coefficients corresponding to the 8 level-2 sub-band sequences out of the obtained 15 linear correlation coefficients, regarding the level-2 sub-band sequences respectively corresponding to the max linear correlation coefficient and the second max linear correlation coefficient as the two level-2 sub-band sequences to be selected.

3. The video quality evaluation method, as recited in claim 1, wherein in the step e), w_{Lv1}=0.71, and W_{Lv2}=0.58.

4. The video quality evaluation method, as recited in claim 2, wherein in the step e), w_{Lv1}=0.71, and W_{Lv2}=0.58.

5. The video quality evaluation method, as recited in claim 3, wherein in the step f), w_{Lv}=0.93.

6. The video quality evaluation method, as recited in claim 4, wherein in the step f) w_{Lv}=0.93.

7. The video quality evaluation method, as recited in claim 5, wherein for obtaining the wⁱ, the step g) specifically comprises steps of:
g-1) calculating an average value of brightness average values of all the images in each of the GOPs of the V_{dis}, marking the average value of the brightness average values of all the images of the G_{dis}ⁱ, as Lavgⁱ, wherein
$${Lavg}^{i} = \frac{{\sum }_{f = 1}^{{2}^{n}} {\partial }_{f}}{{2}^{n}} ,$$
∂_{f} represents the brightness average value of a No. f frame of image, a value of the ∂_{f} is the brightness average value obtained by averaging brightness values of all pixels in the No. f frame of image, and 1≦i≦n_{GoF};
g-2) calculating an average value of motion intensity of all the images of each of the GOPs except a first frame of image in the GOP, marking the average value of motion intensity of all the images of G_{dis}ⁱ except the first frame of image as MAavgⁱ, wherein
$${MAavg}^{i} = \frac{{\sum }_{{f}^{′} = 2}^{{2}^{n}} {MA}_{{f}^{′}}}{{2}^{n} - 1} , 2 \leq {f}^{′} \leq {2}^{n} ,$$
MA_{f′} represents the motion intensity of the No. f′ frame of image of the G_{dis}ⁱ,
$${MA}_{{f}^{′}} = \frac{1}{W \times H} {\sum }_{s = 1}^{W} {\sum }_{t = 1}^{H} ( {( {mv}_{x} ( s , t ) )}^{2} + {( {mv}_{y} ( s , t ) )}^{2} ) ,$$
represents a width of the No. f′ frame of image of the G_{dis}ⁱ, H represents a height of the No. f′ frame of image of the G_{dis}ⁱ, mvₓ (s,t) represents a horizontal value of a motion vector of a pixel with a position of (s,t) in the No. f′ frame of image of the G_{dis}ⁱ, mv_{y} (s,t) represents a vertical value of the motion vector of the pixel with the position of (s,t) in the No. f′ frame of image of the G_{dis}ⁱ;
g-3) forming a brightness average value vector with the average values of the brightness average values of all the images of the GOPs of the V_{dis}, marking the brightness average value vector as V_{Lavg}, wherein V_{Lavg}=(Lavg¹, Lavg², . . . , Lavgⁿ^{_{GoF}}), Lavg¹ represents an average value of the brightness average values of images of the first GOP of the V_{dis}, Lavg² represents an average value of the brightness average values of images of the second GOP of the V_{dis}, Lavgⁿ^{_{GoF}} represents an average value of the brightness average values of images of the No. n_{GoF} GOP of the V_{dis};
and forming an average value vector of the motion intensity with the average values of the motion intensity of all the images of the GOPs of the V_{dis} except the first frame of image, marking the average value vector of the motion intensity as V_{MAavg}, wherein V_{MAavg}=(MAavg¹, MAavg², . . . , MAavgⁿ^{_{GoF}}), MAavg¹ represents an average value of the motion intensity of images of the first GOP of the V_{dis} except the first frame of image, MAavg² represents an average value of the motion intensity of images of the second GOP of the V_{dis} except the first frame of image, MAavgⁿ^{_{GoF}} represents an average value of the motion intensity of images of the No. n_{GoF} GOP of the V_{dis} except the first frame of image;
g-4) normalizing every element of the V_{Lavg}, for obtaining normalized values of the elements of the V_{Lavg}, marking the normalized value of the No. i element of the V_{Lavg} as v_{Lavg}^{i,norm}, wherein
$${v}_{Lavg}^{i , norm} = \frac{{Lavg}^{i} - max ( {V}_{Lavg} )}{max ( {V}_{Lavg} ) - min ( {V}_{Lavg} )} ,$$
Lavgⁱ represents a value of the No. i element of the V_{Lavg}, max(V_{Lavg}) represents a value of the element with a max value of the V_{Lavg}, min(V_{Lavg}) represents a value of the element with a min value of the V_{Lavg};
and normalizing every element of the V_{MAavg}, for obtaining normalized values of the elements of the V_{MAavg}, marking the normalized value of the No. i element of the V_{MAavg} as v_{MAavg}^{i,norm}, wherein
$${v}_{MAavg}^{i , norm} = \frac{{MAavg}^{i} - max ( {V}_{MAavg} )}{max ( {V}_{MAavg} ) - min ( {V}_{MAavg} )} ,$$
MAavgⁱ represents a value of the No. i element of the V_{MAavg}, max(V_{MAavg}) represents a value of the element with a max value of the V_{MAavg}, min(V_{MAavg}) represents a value of the element with a min value of the V_{MAavg}; and
g-5) calculating the weight value wⁱ of the Q_{Lv}ⁱ according to the v_{Lavg}^{i,norm} and the V_{MAavg}^{i,norm}, wherein wⁱ=(1−v_{MAavg}^{i,norm})×v_{Lavg}^{i,norm}.

8. The video quality evaluation method, as recited in claim 6, wherein for obtaining the wⁱ, the step g) specifically comprises steps of:
g-1) calculating an average value of brightness average values of all the images in each of the GOPs of the V_{dis}, marking the average value of the brightness average values of all the images of the G_{dis}ⁱ as Lavgⁱ, wherein
$${Lavg}^{i} = \frac{{\sum }_{f = 1}^{{2}^{n}} {\partial }_{f}}{{2}^{n}} ,$$
∂_{f} represents the brightness average value of a No. f frame of image, a value of the ∂_{f} is the brightness average value obtained by averaging brightness values of all pixels in the No. f frame of image, and 1≧i≦n_{GoF};
g-2) calculating an average value of motion intensity of all the images of each of the GOPs except a first frame of image in the GOP, marking the average value of motion intensity of all the images of G_{dis}ⁱ except the first frame of image as MAavgⁱ, wherein
$${MAavg}^{i} = \frac{{\sum }_{{f}^{′} = 2}^{{2}^{n}} {MA}_{{f}^{′}}}{{2}^{n} - 1} , 2 \leq {f}^{′} \leq {2}^{n} ,$$
MA_{f′} represents the motion intensity of the No. f′ frame of image of the G_{dis}ⁱ,
$${MA}_{{f}^{′}} = \frac{1}{W \times H} {\sum }_{s = 1}^{W} {\sum }_{t = 1}^{H} ( {( {mv}_{x} ( s , t ) )}^{2} + {( {mv}_{y} ( s , t ) )}^{2} ) ,$$
represents a width of the No. f′ frame of image of the G_{dis}ⁱ, H represents a height of the No. f′ frame of image of the G_{dis}ⁱ, mvₓ (s,t) represents a horizontal value of a motion vector of a pixel with a position of (s,t) in the No. f′ frame of image of the G_{dis}ⁱ, mv_{y} (s,t) represents a vertical value of the motion vector of the pixel with the position of (s,t) in the No. f′ frame of image of the G_{dis}ⁱ;
g-3) forming a brightness average value vector with the average values of the brightness average values of all the images of the GOPs of the V_{dis}, marking the brightness average value vector as V_{Lavg}, wherein V_{Lavg}=(Lavg¹, Lavg², . . . , Lavgⁿ^{_{GoF}}), Lavg¹ represents an average value of the brightness average values of images of the first GOP of the V_{dis}, Lavg² represents an average value of the brightness average values of images of the second GOP of the V_{dis}, Lavgⁿ^{_{GoF}} represents an average value of the brightness average values of images of the No. n_{GoF} GOP of the V_{dis};
and forming an average value vector of the motion intensity with the average values of the motion intensity of all the images of the GOPs of the V_{dis} except the first frame of image, marking the average value vector of the motion intensity as V_{MAavg}, wherein V_{MAavg}=(MAavg¹, MAavg², . . . , MAavgⁿ^{_{GoF}}), MAavg¹ represents an average value of the motion intensity of images of the first GOP of the V_{dis} except the first frame of image, MAavg² represents an average value of the motion intensity of images of the second GOP of the V_{dis} except the first frame of image, MAavgⁿ^{_{GoF}} represents an average value of the motion intensity of images of the No. n_{GoF} GOP of the V_{dis} except the first frame of image;
g-4) normalizing every element of the V_{Lavg}, for obtaining normalized values of the elements of the V_{Lavg}, marking the normalized value of the No. i element of the V_{Lavg} as v_{Lavg}^{i,norm}, wherein
$${v}_{Lavg}^{i , norm} = \frac{{Lavg}^{i} - max ( {V}_{Lavg} )}{max ( {V}_{Lavg} ) - min ( {V}_{Lavg} )} ,$$
Lavgⁱ represents a value of the No. i element of the V_{Lavg}, max(V_{Lavg}) represents a value of the element with a max value of the V_{Lavg}, min(V_{Lavg}) represents a value of the element with a min value of the V_{Lavg};
and normalizing every element of the V_{MAavg}, for obtaining normalized values of the elements of the V_{MAavg}, marking the normalized value of the No. i element of the V_{MAavg} as v_{MAavg}^{i,norm}, wherein
$${v}_{MAavg}^{i , norm} = \frac{{MAavg}^{i} - max ( {V}_{MAavg} )}{max ( {V}_{MAavg} ) - min ( {V}_{MAavg} )} ,$$
MAavgⁱ represents a value of the No. i element of the V_{MAavg}, max(V_{MAavg}) represents a value of the element with a max value of the V_{MAavg}, min(V_{MAavg}) represents a value of the element with a min value of the V_{MAavg}; and
g-5) calculating the weight value wⁱ of the Q_{Lv}ⁱ according to the v_{Lavg}^{i,norm} and the v_{MAavg}^{i,norm}, wherein wⁱ=(1−v_{MAavg}^{i,norm})×v_{Lavg}^{i,norm}.
